(19) United States
(12) Patent Application Publication
(10) Pub. No.: US 2015/0192814 A1
(43) Pub. Date: Jul. 9, 2015

(54) LIQUID CRYSTAL DISPLAY DEVICE

(71) Applicant: Panasonic Intellectual Property Management Co., Ltd., Osaka (JP)

(72) Inventors: Naoki KOSUGI, Kyoto (JP); Manabu INOUE, Osaka (JP); Takahito NAKAYAMA, Osaka (JP); Shigeo KASAHARA, Hyogo (JP); Hiroyuki KADO, Osaka (JP); Akira TOKAI, Hyogo (JP); Kazushige TAKAGI, Osaka (JP)

(21) Appl. No.: 14/664,195

(22) Filed: Mar. 20, 2015

Related U.S. Application Data
(63) Continuation of application No. PCT/JP2013/005637, filed on Sep. 24, 2013.

(30) Foreign Application Priority Data
Sep. 24, 2012 (JP) 2012-209208

(51) Int. Cl. G02F 1/1333; G06F 3/044; G02F 1/1368

(52) U.S. Cl. CPC G02F 1/13338; G02F 1/1368; G06F 3/044; G02F 2001/136218

(57) ABSTRACT

An object of the present technology is to provide an input device as a capacitance coupling type input device capable of easily being incorporated into a display device. A liquid crystal display device of the present technology includes: a liquid crystal panel 1 having a plurality of pixel electrodes 19 and a common electrode provided so as to be opposed to the pixel electrodes 19, and updating a display by sequentially applying a scanning signal to TFTs that control application of a voltage to the pixel electrodes 19; and an input device having a plurality of driving electrodes 11, which are formed by dividing the common electrode of the liquid crystal panel 1 by providing a slit 25, and a plurality of detection electrodes 12 arranged so as to cross the driving electrodes 11, and capacitive elements formed between the driving electrodes 11 and the detection electrodes 12. A shielding electrode 26 is arranged at a position corresponding to the slit 25 in the periphery of the pixel electrodes 19.

### TECHNICAL FIELD

The present technology relates to a liquid crystal display device that includes a capacitance coupling type input device capable of performing data input by detecting a touched position on a screen and a liquid crystal panel.

### BACKGROUND ART

A display device including an input device having a screen input function that inputs information through a touch operation by a user's finger on a display screen has been used in mobile electronic equipment such as a PDA and a portable terminal, various household electrical products, and stationary customer guidance terminals such as an unattended reception machine. As the above-mentioned input device involving a touch operation, various systems have been known, such as a resistive film system (resistive touch screen) that detects a change in the resistance value of a touched portion, a capacitance coupling system (capacitive touch screen) that detects a change in capacitance, and an optical sensor system that detects a change in light amount in a portion shielded by a touch.

Of those various systems, the capacitance coupling system has the following advantages compared with the resistive film system and the optical sensor system. For example, the transmittance of a touch device is as low as about 80% in the resistive film system and the optical sensor system, whereas the transmittance of a touch device is as high as about 90%, and the image quality of a display image is not degraded, in the capacitance coupling system. Further, the resistive film system has a risk of a resistive film being degraded or damaged because a touch position is detected by the mechanical contact of the resistive film, whereas the capacitance coupling system involves no mechanical contact such as the contact of a detection electrode with another electrode, and hence is advantageous also from the viewpoint of durability.

As a capacitance coupling type input device, for example, there is given a system as disclosed by Patent Document 1.

### PRIOR ART DOCUMENT

### Patent Document

Patent Document 1: JP 2011-90458 A

### SUMMARY OF INVENTION

### Problem to be Solved by the Invention

It is an object of the present technology to obtain a liquid crystal display device that combines such a capacitance coupling type input device and a liquid crystal panel as an image display element.

### Means for Solving Problem

In order to solve the above-mentioned problem, a liquid crystal display device of the present technology includes: a liquid crystal panel having a plurality of pixel electrodes and a common electrode provided so as to be opposed to the pixel electrodes, and updating a display by sequentially applying a scanning signal to switching elements that control application of a voltage to the pixel electrodes; and an input device having a plurality of driving electrodes formed in the liquid crystal panel and a plurality of detection electrodes arranged so as to cross the driving electrodes, and capacitive elements formed between the driving electrodes and the detection electrodes. In the input device, the driving electrodes are formed by dividing the common electrode of the liquid crystal panel by providing a slit in the periphery of the pixel electrodes, and a shielding electrode is arranged at a position corresponding to the slit.

### Effects of the Invention

According to the present technology, it is possible to provide a liquid crystal display device that includes an input device as a capacitance coupling type input device capable of easily being incorporated into a display device.

### BRIEF DESCRIPTION OF DRAWINGS

FIG. 1 is a block diagram illustrating an overall configuration of a liquid crystal display device having a touch sensor function according to the present embodiment.

FIG. 2 is an exploded perspective view showing an example of an arrangement of driving electrodes and detection electrodes forming a touch sensor.

FIG. 3 shows explanatory diagrams illustrating a state in which a touch operation is not being performed and a state in which a touch operation is being performed, regarding a schematic configuration and an equivalent circuit of the touch sensor.

FIG. 4 is an explanatory diagram showing changes in detection signal in the case where a touch operation is not being performed and in the case where a touch operation is being performed.

FIG. 5 is a schematic diagram showing an arrangement structure of scanning signal lines of a liquid crystal panel and an arrangement structure of driving electrodes and detection electrodes of a touch sensor.

FIG. 6 shows explanatory diagrams showing an example of a relationship between the input of a scanning signal to a line block of the scanning signal lines for updating a display of the liquid crystal panel, and the application of a driving signal to a line block of the driving electrodes for performing touch detection of the touch sensor.

FIG. 7 is a timing chart showing a state of the application of a scanning signal and a driving signal during one horizontal scanning period.

FIG. 8 is a timing chart illustrating an example of a relationship between the display update period and the touch detection period during one horizontal scanning period.

FIG. 9 is an explanatory diagram showing a configuration of the liquid crystal panel of the liquid crystal display device having a touch sensor function according to the present embodiment.

FIG. 10 is an enlarged explanatory diagram showing a schematic configuration of driving electrodes and detection electrodes forming a touch sensor, including a terminal lead-out portion.

FIG. 11 is a plan view showing a configuration of a connection between lead-out wiring portions and a common win onion of the touch sensor.

FIG. 12 is a cross-sectional view showing the configuration of the connection portion between the lead-out wiring portions and the common wiring portion of the touch sensor.

FIG. 13 is a plan view showing an example of an electrode configuration of a pixel region in which the detection electrode of a touch panel is arranged and the periphery of the pixel region, in the liquid crystal panel according to the present embodiment.

FIG. 14 shows schematic plan views illustrating respective arrangements of the driving electrodes and the detection electrodes in the touch sensor according to the present embodiment.

FIG. 15A is an enlarged schematic plan view showing arrangement states of the driving electrodes and the detection electrodes in the touch sensor according to the present embodiment.

FIG. 15B is an enlarged schematic plan view showing an arrangement of the detection electrodes in the touch sensor according to the present embodiment.

FIG. 15C is an enlarged schematic plan view showing an arrangement of the driving electrodes in the touch sensor according to the present embodiment.

FIG. 15D is an enlarged plan view showing a configuration of a boundary portion of the driving electrode and the detection electrode in the touch sensor according to the present embodiment.

FIG. 16 shows enlarged cross-sectional views respectively illustrating an electrode configuration of a portion where the driving electrode is arranged and an electrode configuration of a portion where the detection electrode is arranged in the liquid crystal panel according to the present embodiment.

FIG. 17 is an equivalent circuit diagram between the driving electrode and the detection electrode.

FIG. 18 shows cross-sectional views illustrating an electrode configuration and an effect of the liquid crystal panel in another example according to the present embodiment.

FIG. 19 is a cross-sectional view showing a detailed structure of the detection electrode in the touch sensor according to the present embodiment.

### DESCRIPTION OF THE INVENTION

The liquid crystal display device of the present technology includes: a liquid crystal panel having a plurality of pixel electrodes and a common electrode provided so as to be opposed to the pixel electrodes, and updating a display by sequentially applying a scanning signal to switching elements that control application of a voltage to the pixel electrodes; and an input device having a plurality of driving electrodes formed in the liquid crystal panel and a plurality of detection electrodes arranged so as to cross the driving electrodes, and capacitive elements formed between the driving electrodes and the detection electrodes. In the input device, the driving electrodes are formed by dividing the common electrode of the liquid crystal panel by providing a slit in the periphery of the pixel electrodes, and a shielding electrode is arranged at a position corresponding to the slit.

In the liquid crystal display device of the present technology, the driving electrodes of the input device are formed by dividing the common electrode by providing a slit in the periphery of the pixel electrodes in the common electrode of the liquid crystal panel, and a shielding electrode is arranged at a position corresponding to the slit. Because of this, the electrodes of the input device can be configured easily using the electrode used for displaying an image in the liquid crystal panel, and the disorder of the alignment of liquid crystals due to the electric field leakage caused by formation of the slit can be prevented. Thereby, it is possible to realize a liquid crystal display device having a simple structure and having a touch sensor function that allows a favorable image display.

Further, in the liquid crystal display device of the present technology, preferably, the shielding electrode is set at the same potential as that of a voltage applied to the common electrode. By doing so, the display driving in the liquid crystal panel can be prevented from being affected by the potential applied to the shielding electrode.

### Embodiment

Hereinafter, a liquid crystal display device according to one embodiment of the present technology will be described with reference to the drawings. Note that the present embodiment is shown merely for an illustrative purpose. The present technology is not limited to the configuration shown in this embodiment.

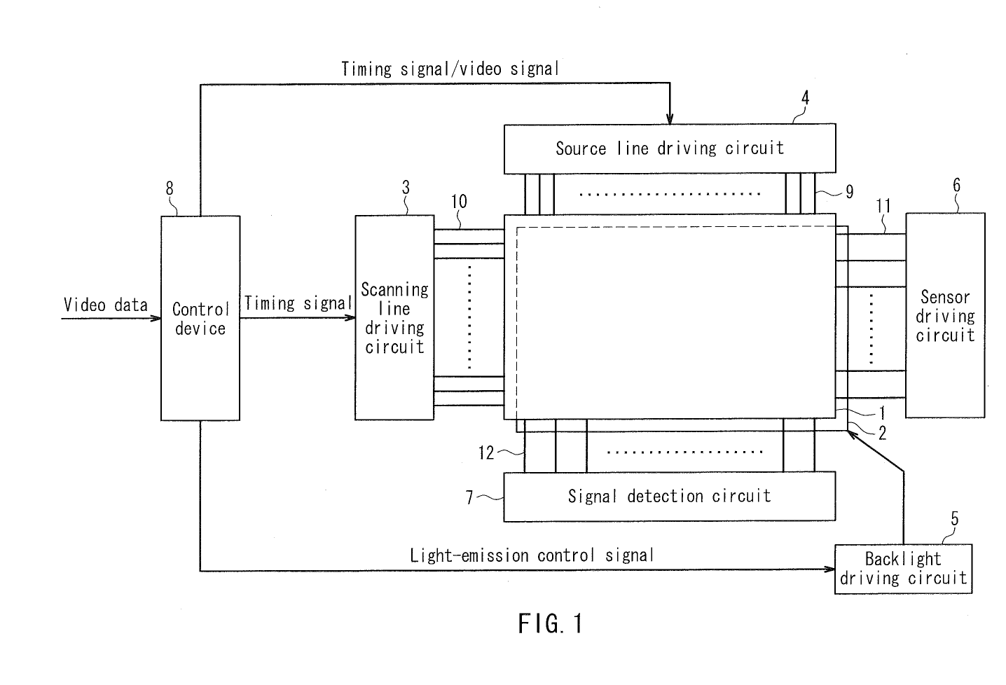

FIG. 1 is a block diagram illustrating an overall configuration of a liquid crystal display device having a touch sensor function according to an embodiment of the present technology.

As shown in FIG. 1, the liquid crystal display device includes a liquid crystal panel 1, a backlight unit 2, a scanning line driving circuit 3, a source line driving circuit 4, a backlight driving circuit 5, a sensor driving circuit 6, a signal detection circuit 7, and a control device 8.

The liquid crystal panel 1 has a rectangular plate shape, and includes a TFT substrate formed of a transparent substrate such as a glass substrate, and a counter substrate arranged so as to be opposed to the TFT substrate with a predetermined gap formed therebetween. A liquid crystal material is sealed between the TFT substrate and the counter substrate.

The TFT substrate is located on a back surface side of the liquid crystal panel 1, and has a configuration in which pixel electrodes arranged in a matrix, thin film transistors (TFT) that are provided so as to correspond to the respective pixel electrodes and that serve as switching elements for controlling ON/OFF of the application of a voltage to a pixel electrode, a common electrode, and the like are formed on a transparent substrate made of glass serving as a base.

Further, the counter substrate is located on a front surface side of the liquid crystal panel 1, and has a configuration in which color filters (CF) of three primary colors: red (R), green (G), and blue (B) respectively constituting sub-pixels are arranged at positions corresponding to the pixel electrodes of the TFT substrate on a transparent substrate made of glass or the like serving as a base. Further, a black matrix made of a light-shielding material for enhancing contrast can be arranged between the sub-pixels of RGB and/or between pixels formed of the sub-pixels on the counter substrate. Note that, in the present embodiment, as a TFT to be formed correspondingly to each pixel electrode of the TFT substrate, an n-channel type TFT including a drain electrode and a source electrode is exemplified.

On the TFT substrate, a plurality of video signal lines 9 and a plurality of scanning signal lines 10 are formed so as to cross each other substantially at right angles. Each scanning signal line 10 is provided for a horizontal row of the TFTs and connected commonly to gate electrodes of a plurality of the TFTs in the horizontal row. Each video signal line 9 is provided for a vertical row of the TFTs and connected commonly to drain electrodes of a plurality of the TFTs in the vertical row. Further, a source electrode of each TFT is connected to a pixel electrode arranged in a pixel region corresponding to the TFT.

Each TFT formed on the TFT substrate is turned on/off in a unit of a horizontal row in accordance with a scanning signal to be applied to the scanning signal line 10. Each TFT in a horizontal row, which has been turned on, sets an electric potential of a pixel electrode connected to each TFT to an electric potential (pixel voltage) in accordance with a video signal to be applied to the video signal line 9. The liquid crystal panel 1 includes a plurality of the pixel electrodes and a common electrode provided so as to be opposed to the pixel electrodes. The liquid crystal panel 1 controls the alignment of liquid crystals for each pixel region with an electric field generated between the pixel electrodes and the common electrode to change a transmittance with respect to light entering the liquid crystal panel 1 from the backlight unit 2, thereby forming an image on a display screen.

The backlight unit 2 is disposed on a back surface side of the liquid crystal panel 1 and irradiates the liquid crystal panel 1 with light from the back surface thereof. As the backlight unit 2, for example, the following are known: a backlight unit having a structure in which a plurality of light-emitting diodes are arranged to form a surface light source; and a backlight unit having a structure in which a light-guiding plate and a diffuse reflection plate are used in combination, and light from light-emitting diodes is used as a surface light source.

The scanning line driving circuit 3 is connected to a plurality of the scanning signal lines 10 formed on the TFT substrate.

The scanning line driving circuit 3 sequentially selects the scanning signal lines 10 in response to a timing signal input from the control device 8 and applies a voltage for turning on the TFTs of the selected scanning signal line 10. For example, the scanning line driving circuit 3 includes a shift register. The shift register starts its operation in response to a trigger signal from the control device 8, and the operation involves sequentially selecting the scanning signal lines 10 in the order along a vertical scanning direction and outputting a scanning pulse to the selected scanning signal line 10.

The source line driving circuit 4 is connected to a plurality of the video signal lines 9 formed on the TFT substrate.

The source line driving circuit 4 applies a voltage, which corresponds to a video signal representing a gray-scale value of each sub-pixel, to each TFT connected to the selected scanning signal line 10, in accordance with the selection of the scanning signal line 10 by the scanning line driving circuit 3. As a result, a video signal is written in each pixel electrode arranged in the sub-pixel corresponding to the selected scanning signal line 10.

The backlight driving circuit 5 causes the backlight unit 2 to emit light at a timing and brightness in accordance with a light-emission control signal input from the control device 8.

A plurality of driving electrodes 11 and a plurality of detection electrodes 12 are arranged so as to cross each other as electrodes forming a touch sensor as an input device on the liquid crystal panel 1.

The touch sensor composed of the driving electrodes 11 and the detection electrodes 12 detects the contact of an object with a display surface by inputting an electric signal and detecting a response based on a change in capacitance between the driving electrodes 11 and the detection electrodes 12. As an electric circuit for detecting the contact, a sensor driving circuit 6 and a signal detection circuit 7 are provided.

The sensor driving circuit 6 is an AC signal source and is connected to the driving electrodes 11. For example, the sensor driving circuit 6 receives a timing signal from the control device 8, selects the driving electrodes 11 sequentially in synchronization with an image display of the liquid crystal panel 1, and applies a driving signal Txv based on a rectangular pulse voltage to the selected driving electrode 11. More specifically, the sensor driving circuit 6 includes a shift register in the same way as the scanning line driving circuit 3, operates the shift register in response to a trigger signal from the control device 8 to select the driving electrodes 11 sequentially in the order along the vertical scanning direction, and applies the driving signal Txv based on a pulse voltage to the selected driving electrode 11.

Note that the driving electrodes 11 and the scanning signal lines 10 are formed on the TFT substrate so as to extend in the horizontal direction and are arranged in a plural number in the vertical direction. It is desired that the sensor driving circuit 6 and the scanning line driving circuit 3 electrically connected to the driving electrodes 11 and the scanning signal lines 10 are arranged along a vertical side of a display region in which pixels are arranged. In the liquid crystal display device of the present embodiment, the scanning line driving circuit 3 is disposed on one of the right and left sides, and the sensor driving circuit 6 is disposed on the other side.

The signal detection circuit 7 is a detection circuit for detecting a change in capacitance and is connected to the detection electrodes 12. The signal detection circuit 7 is provided with a detection circuit for each detection electrode 12 and detects a voltage of the detection electrode 12 as a detection signal Rxv. Note that another configuration example of the signal detection circuit may be as follows: one signal detection circuit is provided for a group of a plurality of detection electrodes 12, and the voltage of the detection signal Rxv of the plurality of detection electrodes 12 is monitored in a time-division manner during the duration time of a pulse voltage applied to the driving electrodes 11 to detect the detection signal Rxv from the respective detection electrodes 12.

A contact position of an object on a display surface, that is, a touch position, is determined based on which detection electrode 12 detects a detection signal Rxv at a time of contact when the driving signal Txv is applied to which driving electrode 11, and an intersection between the driving electrode 11 and the detection electrode 12 is determined as a contact position by an arithmetic calculation. Note that as a calculation method for determining a contact position, there may be given a method using a calculation circuit provided in a liquid crystal display device and a method using a calculation circuit provided outside of the liquid crystal display device.

The control device 8 includes a calculation processing circuit such as a CPU and memories such as a ROM and a RAM. The control device 8 performs various image signal processing such as color adjustment to generate an image signal indicating a gray-scale value of each pixel based on input video data and applies the image signal to the source line driving circuit 4. Further, the control device 8 generates a timing signal for synchronizing the operations of the scanning line driving circuit 3, the source line driving circuit 4, the backlight driving circuit 5, the sensor driving circuit 6, and the signal detection circuit 7 based on the input video data and applies the timing signal to those circuits. Further, the control device 8 applies a brightness signal for controlling the brightness of a light-emitting diode based on the input video data as a light-emission control signal to the backlight driving circuit 5.

In the liquid crystal display device described in the present embodiment, the scanning line driving circuit 3, the source line driving circuit 4, the sensor driving circuit 6, and the signal detection circuit 7 connected to respective signal lines and electrodes of the liquid crystal panel 1 are configured by mounting semiconductor chips of the respective circuits on a flexible wiring board, a printed wiring board, and a glass substrate. However, the scanning line driving circuit 3, the source line driving circuit 4, and the sensor driving circuit 6 may be mounted on the TFT substrate by simultaneously forming predetermined electronic circuits such as a semiconductor circuit element together with TFTs and the like.

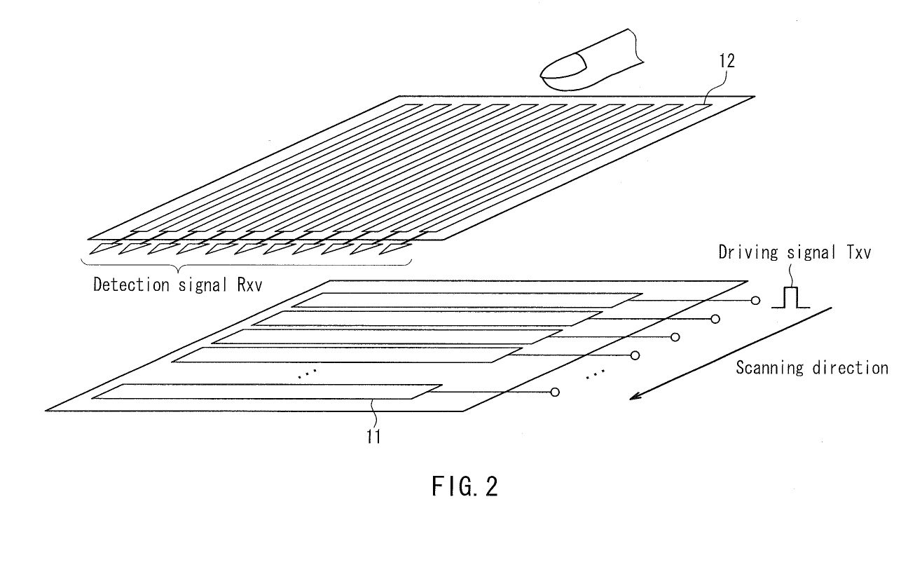

FIG. 2 is a perspective view showing an example of the arrangement of the driving electrodes and the detection electrodes forming the touch sensor.

As shown in FIG. 2, the touch sensor serving as an input device is formed of the driving electrodes 11 as a stripe-shaped electrode pattern of a plurality of electrodes extending in the right and left directions of FIG. 2 and the detection electrodes 12 as a stripe-shaped electrode pattern of a plurality of electrodes extending in a direction crossing the extending direction of the electrode pattern of the driving electrodes 11. A capacitive element having capacitance is formed at each location where the driving electrode 11 and the detection electrode 12 cross each other.

Further, the driving electrodes 11 are arranged so as to extend in a direction parallel to the direction in which the scanning signal lines 10 extend. Then, as described later in detail, the driving electrodes 11 are arranged so as to respectively correspond to a plurality of N (N is a natural number) line blocks, with M (M is a natural number) scanning signal lines being one line block, in such a manner that a driving signal is applied on a line block basis.

When an operation of detecting a touch position is performed, one line block to be detected is sequentially selected by applying the driving signal Txv to the driving electrode 11 from the sensor driving circuit 6 so as to scan each line block in line sequence in a time-division manner. Further, when the detection signal Rxv is output from the detection electrode 12, a touch position of one line block is detected.

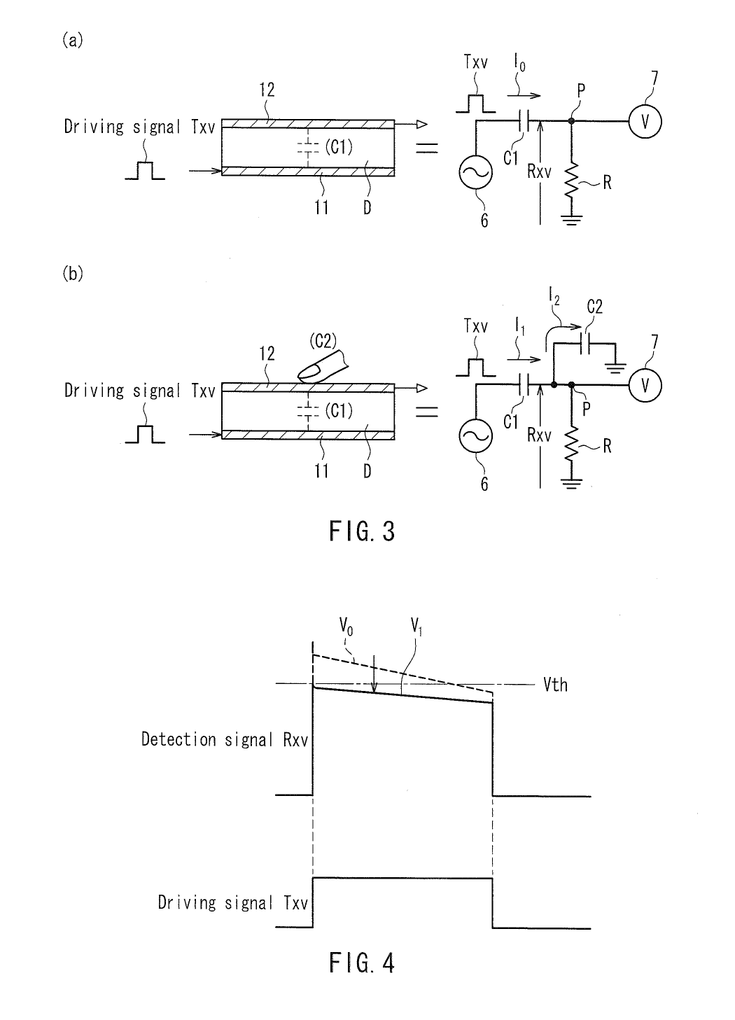

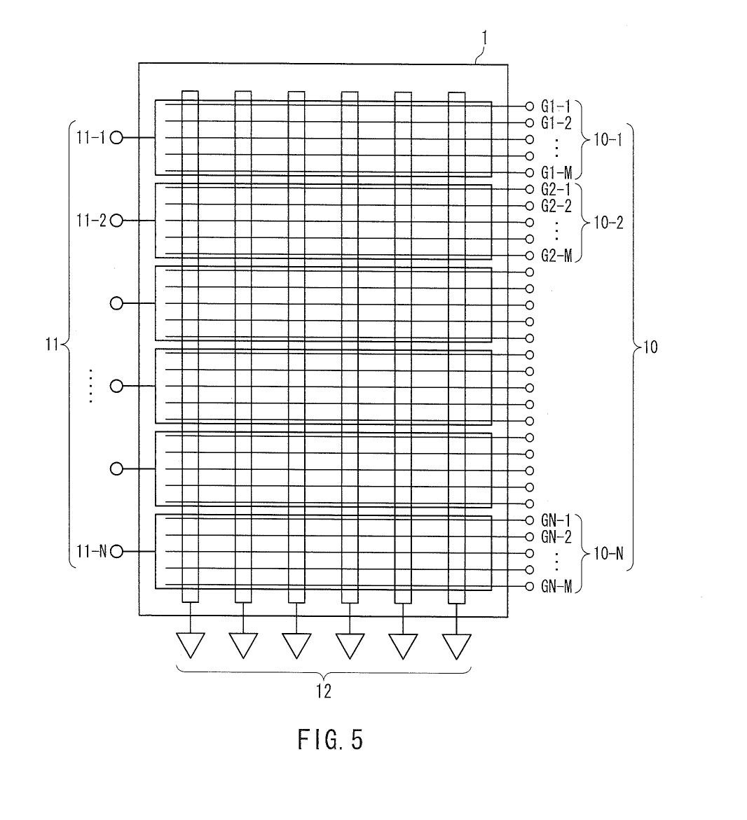

Next, a principle of detecting a touch position in a capacitive touch sensor (voltage detection system) will be described with reference to FIGS. 3 and 4.

FIGS. 3(a) and 3(b) are explanatory diagrams illustrating a state in which a touch operation is not being performed (FIG. 3(a)) and a state in which the touch operation is being performed (FIG. 3(b)), regarding a schematic configuration and an equivalent circuit of the touch sensor. FIG. 4 is an explanatory diagram illustrating a change in detection signal in the case where a touch operation is not being performed and the case where the touch operation is being performed as shown in FIG. 3.

As shown in FIG. 2, in the capacitive touch sensor, a crossed portion between each pair of the driving electrodes 11 and the detection electrodes 12 arranged in a matrix so as to cross each other forms a capacitive element in which the driving electrode 11 and the detection electrode 12 are opposed to each other with a dielectric D interposed therebetween as shown in FIG. 3(a). The equivalent circuit is expressed as shown on the right side of FIG. 3(a), and the driving electrode 11, the detection electrode 12, and the dielectric D form a capacitive element C1. One end of the capacitive element C1 is connected to the sensor driving circuit 6 serving as an AC signal source, and the other end P thereof is grounded through a resistor R and connected to the signal detection circuit 7 serving as a voltage detector.

When the driving signal Txv (FIG. 4) based on a pulse voltage with a predetermined frequency of about several kHz to a dozen kHz is applied to the driving electrode 11 (one end of the capacitive element C1) from the sensor driving circuit 6 serving as an AC signal source, an output waveform (detection signal Rxv) as shown in FIG. 4 appears in the detection electrode 12 (other end P of the capacitive element C1).

When a finger is not in contact with (or is not close to) a display screen, a current I₀ in accordance with a capacitive value of the capacitive element C1 flows along with charge and discharge with respect to the capacitive element C1 as shown in FIG. 3(a). As a potential waveform of the other end P of the capacitive element C1 in this case, a waveform V₀ of FIG. 4 is obtained, and the waveform V₀ is detected by the signal detection circuit 7 serving as a voltage detector.

On the other hand, when a finger is in contact with (or is close to) the display screen, the equivalent circuit takes a form in which a capacitive element C2 formed by the finger is added in series to the capacitive element C1 as shown in FIG. 3(b). In this state, currents I₁ and I₂ flow respectively along with the charge and discharge with respect to the capacitive elements C1 and C2. As the potential waveform of the other end P of the capacitive element C1 in this case, a waveform V₁ of FIG. 4 is obtained, and the waveform V₁ is detected by the signal detection circuit 7 serving as a voltage detector. At this time, the potential at the point P becomes a partial voltage potential determined by the values of the currents I₁ and I₂ respectively flowing through the capacitive elements C1 and C2. Therefore, the waveform V₁ becomes a value smaller than that of the waveform V₀ in a non-contact state.

The signal detection circuit 7 compares the potential of a detection signal output from each of the detection electrodes 12 with a predetermined threshold voltage Vₜₕ. When the potential is equal to or more than the threshold voltage, the signal detection circuit 7 determines that the state is a non-contact state. When the potential is less than the threshold voltage, the signal detection circuit 7 determines that the state is a contact state. Thus, the touch detection becomes possible. Incidentally, in order to perform the touch detection, as a method of detecting a change in capacitance other than the method of making determinations in accordance with the magnitude of voltage as shown in FIG. 4, there is a method of detecting a current, and the like.

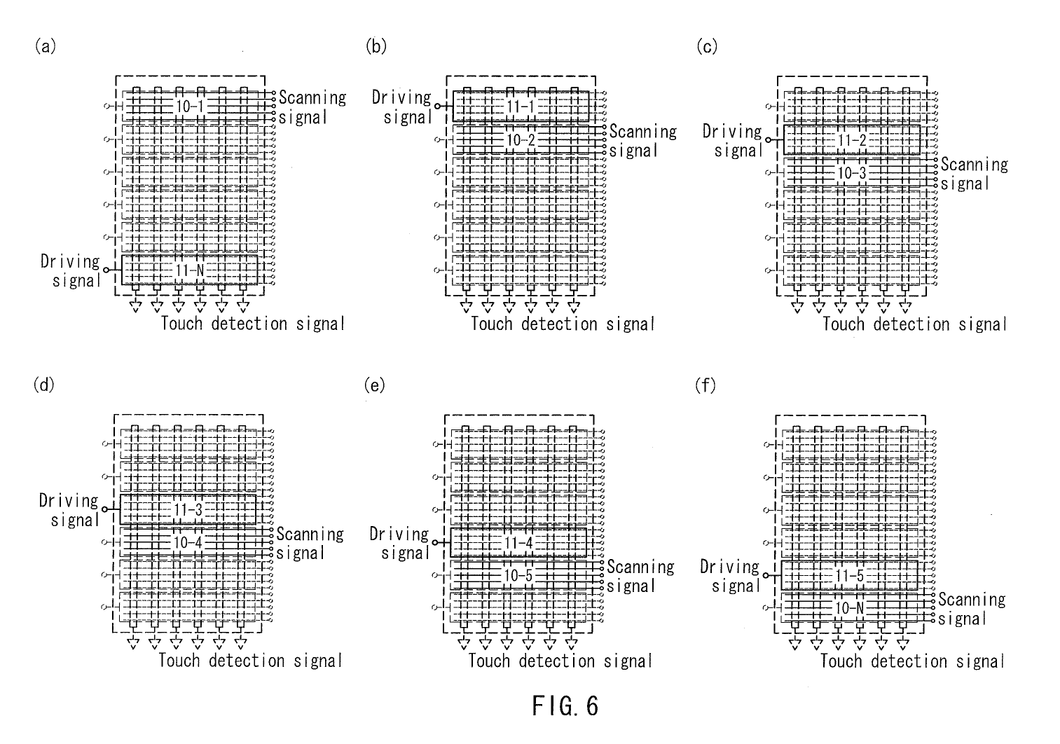

Next, an example of a method for driving a touch sensor of the present technology will be described with reference to FIGS. 5 to 17.

FIG. 5 is a schematic diagram showing an arrangement structure of scanning signal lines of a liquid crystal panel and an arrangement structure of driving electrodes and detection electrodes of the touch sensor.

As shown in FIG. 5, the scanning signal lines 10 extending in the horizontal direction are arranged so as to be divided into a plurality of N (N is a natural number) line blocks 10-1, 10-2, . . . , 10-N, with M (M is a natural number) scanning signal lines G1-1, G1-2, . . . , G1-M being one line block.

The driving electrodes 11 of the touch sensor are arranged so as to respectively correspond to the line blocks 10-1, 10-2, . . . , 10-N, in such a manner that N driving electrodes 11-1, 11-2, . . . , 11-N extend in the horizontal direction. Then, a plurality of detection electrodes 12 are arranged so as to cross the N driving electrodes 11-1, 11-2, . . . , 11-N.

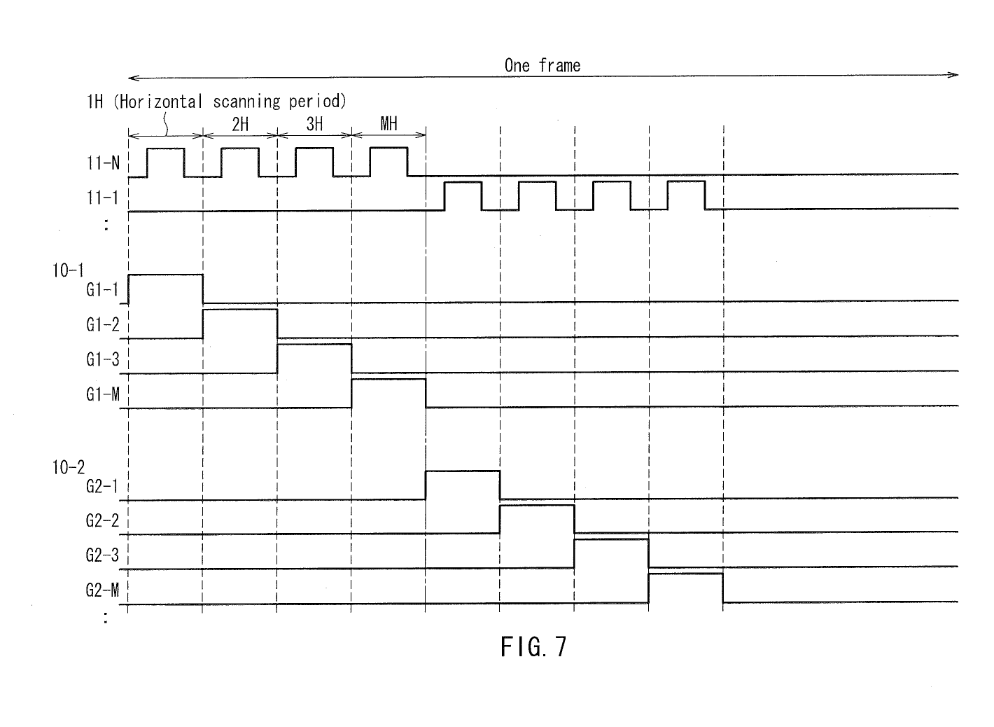

FIG. 6 shows explanatory diagrams showing an example of a relationship between the input timing of a scanning signal to each line block of the scanning signal lines for updating a display image in the liquid crystal panel, and the application timing of a driving signal to the driving electrodes arranged in the respective line blocks for detecting a touch position with the touch sensor. Each of FIGS. 6(a) to 6(f) shows a state during a horizontal scanning period of M scanning signal lines.

As shown in FIG. 6(a), during a horizontal scanning period in which a scanning signal is sequentially input to each of the scanning signal lines in the first line block 10-1 in the uppermost line, a driving signal is applied to the driving electrode 11-N corresponding to the last line block 10-N in the lowermost line. During the subsequent horizontal scanning period, that is, a horizontal scanning period in which a scanning signal is sequentially input to each of the scanning signal lines in the line block 10-2 in the second line from the top as shown in FIG. 6(b), a driving signal is applied to the driving electrode 11-1 corresponding to the first line block 10-1 of one line before the line block 10-2.

While horizontal scanning periods in which a scanning signal is sequentially input to each of the scanning signal lines in the line blocks 10-3, 10-4, 10-5, . . . , 10-N proceed sequentially as shown in FIGS. 6(c) to 6(f), a driving signal is applied to the driving electrodes 11-2, 11-3, 11-4, and 11-5 corresponding to the line blocks 10-2, 10-3, 10-4, and 10-5 of one line before.

That is, in the present technology a driving signal is applied to the plurality of driving electrodes 11 as follows: driving electrodes corresponding to a line block in which a scanning signal is not being applied to the plurality of scanning signal lines are selected, and the driving signal is applied to those selected driving electrodes, during one horizontal scanning period for updating a display.

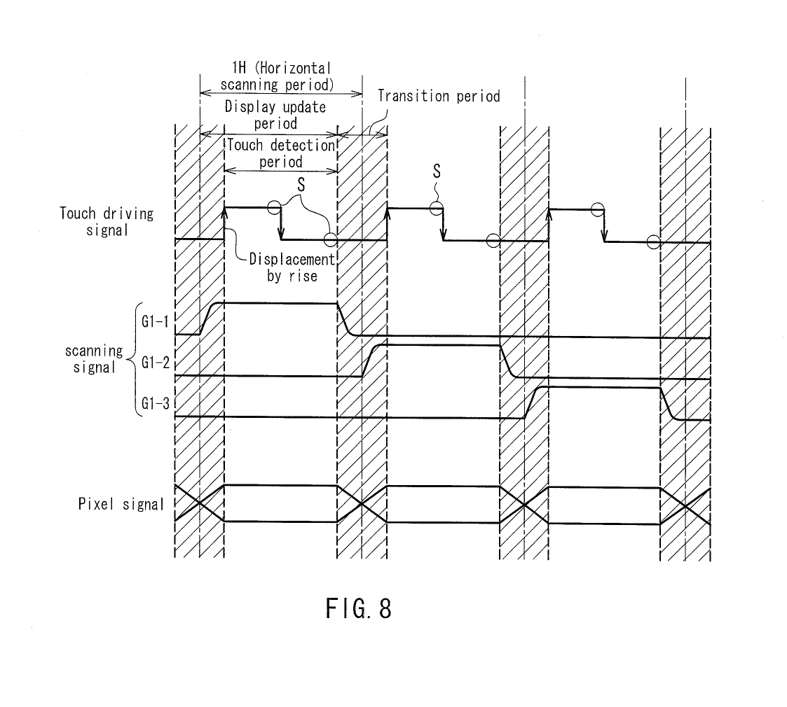

FIG. 7 is a timing chart showing a state of the application of a scanning signal and a driving signal during one horizontal scanning period.

As shown in FIG. 7, during each horizontal scanning period (1H, 2H, 3H, . . . , MH) in one frame period, a scanning signal is input in line sequence to the scanning signal lines 10 for updating a display. Within the period in which the scanning signal is being input, a driving signal for detecting a touch position is applied sequentially to the driving electrodes in line blocks different from line blocks in which a display is being updated in the driving electrodes 11-1, 11-2, . . . , 11-N corresponding to the line block unit of the scanning signal lines (10-1, 10-2, . . . , 10-N).

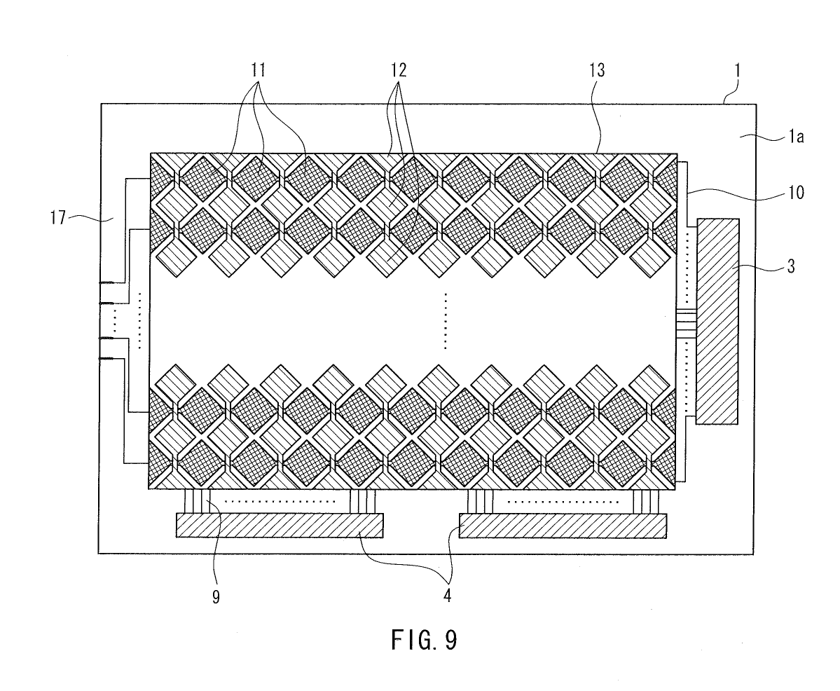

FIG. 8 is a timing chart illustrating an example of a relationship between the display update period during one horizontal scanning period for displaying an image on a liquid crystal display panel and the touch detection period for detecting a touch position with the touch sensor.

As shown in FIG. 8, during a display update period, a scanning signal is sequentially input to the scanning signal lines 10, and a pixel signal in accordance with a video signal to be input is input to the video signal lines 9 connected to switching elements of pixel electrodes of respective pixels. Note that in FIG. 8, a transition period corresponding to a time during which a pulse-shaped scanning signal rises to a predetermined potential and a transition period corresponding to a time during which a pulse-shaped scanning signal falls to a predetermined potential are present before and after the horizontal scanning period.

In the liquid crystal display device of the present embodiment, a touch detection period is provided at the same timing as that of the display update period, and a period obtained by excluding the transition period from the display update period is defined as the touch detection period.

In the example shown in FIG. 8, a pulse voltage serving as a driving signal is applied to the driving electrodes 11 when the transition period, during which a scanning signal rises to a predetermined potential, is completed. Then, the driving voltage pulse falls at almost the midpoint during the touch detection period. In this case, detection timing S of a touch position is present at two places: a falling point of the pulse voltage serving as a driving signal and a touch detection period completion point, as shown in FIG. 8.

Note that the operation of detecting a touch position during the touch detection period is as described with reference to FIGS. 3 and 4.

Next, an electrode configuration of the touch sensor in the liquid crystal display device according to the present embodiment will be described.

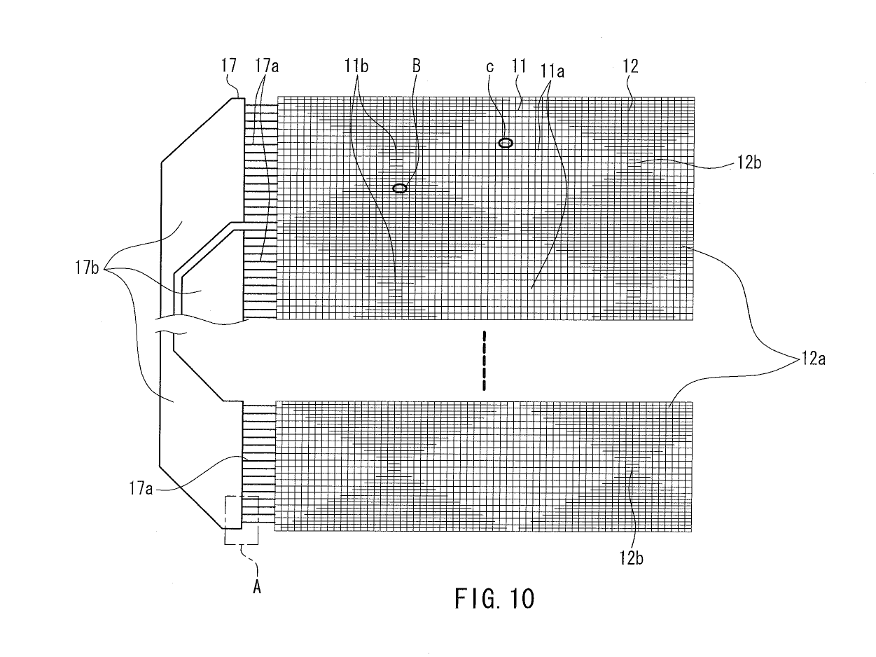

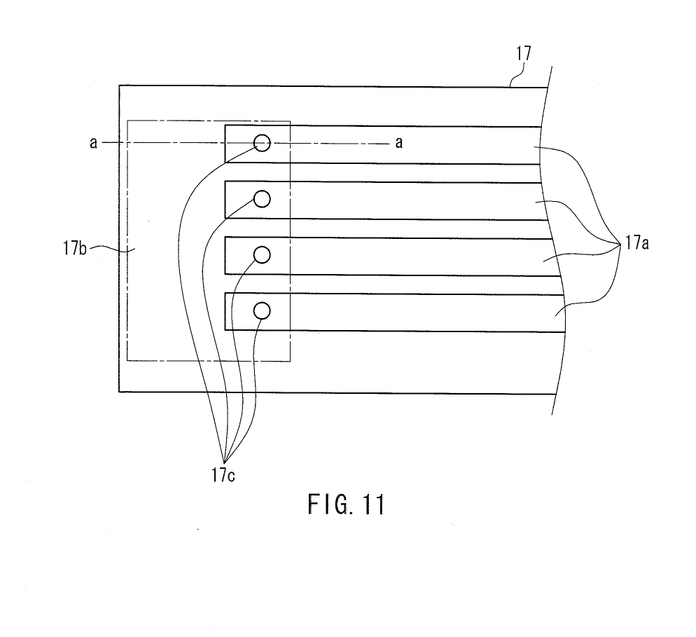

FIG. 9 is an explanatory diagram showing a configuration of the liquid crystal panel in the liquid crystal display device having a touch sensor function according to the present embodiment. FIG. 10 is an enlarged explanatory diagram showing an electrode configuration of the touch sensor, including a terminal lead-out portion. Note that fine quadrangles shown in FIG. 10 each show a pixel array configuration formed of RGB sub-pixels in the liquid crystal panel.

In the liquid crystal panel 1 shown in FIG. 9, pixel electrodes arranged in a matrix, thin film transistors (TFT) that are provided so as to correspond to the respective pixel electrodes and that serve as switching elements for controlling ON/OFF of the application of a voltage to a pixel electrode, a common electrode, and the like are formed on a TFT substrate 1a made of a transparent substrate such as a glass substrate. Thus, an image display region 13 is formed. In FIG. 9, the illustration of the pixel electrodes and TFTs is omitted.

Further, on the TFT substrate 1a, the source line driving circuit 4 connected to the video signal lines 9 and the scanning line driving circuit 3 connected to the scanning signal lines 10 are arranged. As explained using FIG. 1, on the TFT substrate 1a, a plurality of the video signal lines 9 and a plurality of the scanning signal lines 10 are formed so as to cross each other substantially at right angles. Each scanning signal line 10 is provided for a horizontal row of the TFTs and connected commonly to gate electrodes of a plurality of the TFTs in the horizontal row. Each video signal line 9 is provided for a vertical row of the TFTs and connected commonly to drain electrodes of a plurality of the TFTs in the vertical row. Further, a source electrode of each TFT is connected to a pixel electrode arranged in a pixel region corresponding to the TFT.

As shown in FIG. 9, in the image display region 13 of the liquid crystal panel 1, a plurality of the driving electrodes 11 and a plurality of the detection electrodes 12 are arranged so as to cross each other as a pair of electrodes forming a touch sensor. As explained using FIG. 5, the driving electrodes 11 as one of the pair of electrodes forming a touch sensor are formed so that the N driving electrodes 11-1, 11-2, . . . , 11-N extend in the horizontal direction, i.e., in the row direction of the pixel array. Further, the detection electrodes 12 as the other of the pair of electrodes forming a touch sensor are formed in a plural number so as to extend in the vertical direction, i.e., in the column direction of the pixel array so that they cross the above-described N driving electrodes 11-1, 11-2, . . . , 11-N.

As shown in FIGS. 9 and 10, the driving electrode 11 of the touch sensor according to the present embodiment is formed, as one driving electrode 11, by connecting a plurality of rhombic electrode blocks 11a that are arranged separately like islands in the row direction (horizontal direction) by using connection portions 11b that are formed continuously with the electrode blocks 11a in the same layer. The driving electrodes 11 having this configuration are arranged in a plural number in the column direction (vertical direction).

Further, the detection electrode 12 of the touch sensor according to the present embodiment is formed, as one detection electrode 12, by connecting a plurality of rhombic electrode blocks 12a that are arranged separately like islands in the column direction (vertical direction) by using connection portions 12b that are formed continuously with the electrode blocks 12a in the same layer. The detection electrodes 12 having this configuration are arranged in a plural number in the row direction (horizontal direction).

Further, in the touch sensor according to the present embodiment, the respective electrode blocks 11a of the driving electrodes 11 and the respective electrode blocks 12a of the detection electrodes 12 are arranged so as not to be opposed to each other, that is, they are arranged so as not to overlap each other in the thickness direction of the liquid crystal panel. As shown in FIGS. 9 and 10, the driving electrodes 11 and the detection electrodes 12 are rhombic in the central portion of the image display region 13, but they are triangular (i.e., halves of rhombuses) at the edge of the image display region 13.

Further, as shown in FIGS. 9 and 10, a terminal lead-out portion 17 is provided for electrically connecting the respective driving electrodes 11 to the sensor driving circuit 6.

As shown in FIG. 10, the terminal lead-out portion 17 has a plurality of lead-out wiring portions 17a that are led out from the electrode blocks at ends of the driving electrodes 11, and common wiring portions 17b made of a low-resistance metallic material to which the plurality of lead-out wiring portions 17a are connected commonly and electrically. Further, the common wiring portions 17b are wider than the lead-out wiring portions 17a, that is, they are formed in a so-called solid pattern. Note that although only the terminal lead-out portion 17 of the driving electrode 11 is exemplified in FIG. 10, depending on the formation method of the driving electrodes 11 and the detection electrodes 12, similarly to the terminal lead-out portion 17 of the driving electrode 11 shown in FIG. 10, a terminal lead-out portion of the detection electrode 12 also may have a configuration in which respective lead-out wiring portions are connected to wide, solid-patterned common wiring portions.

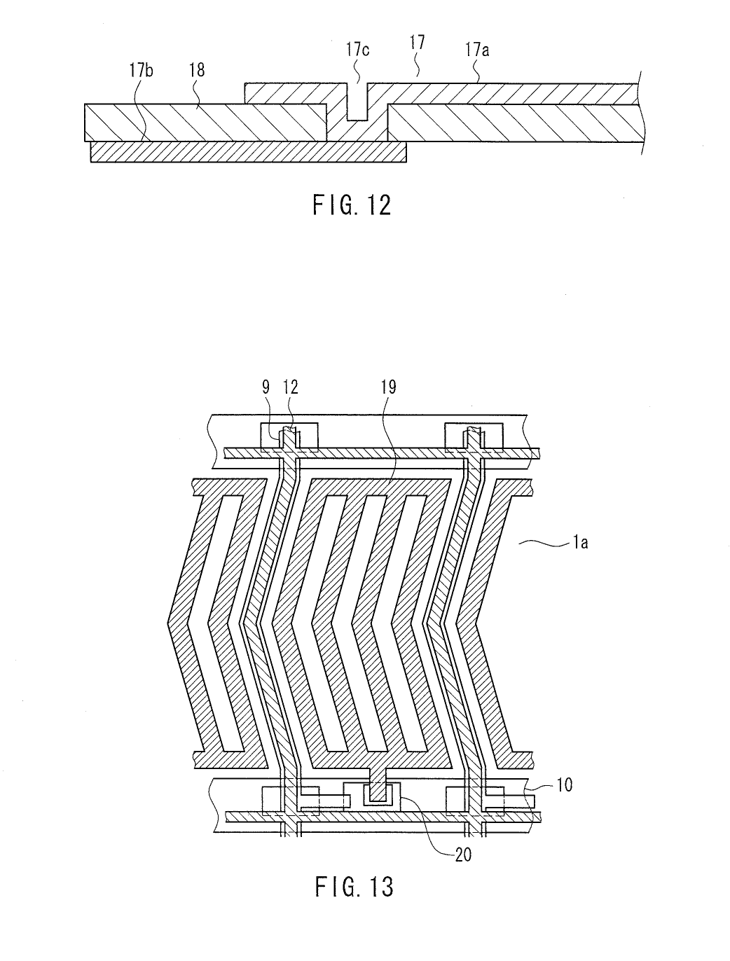

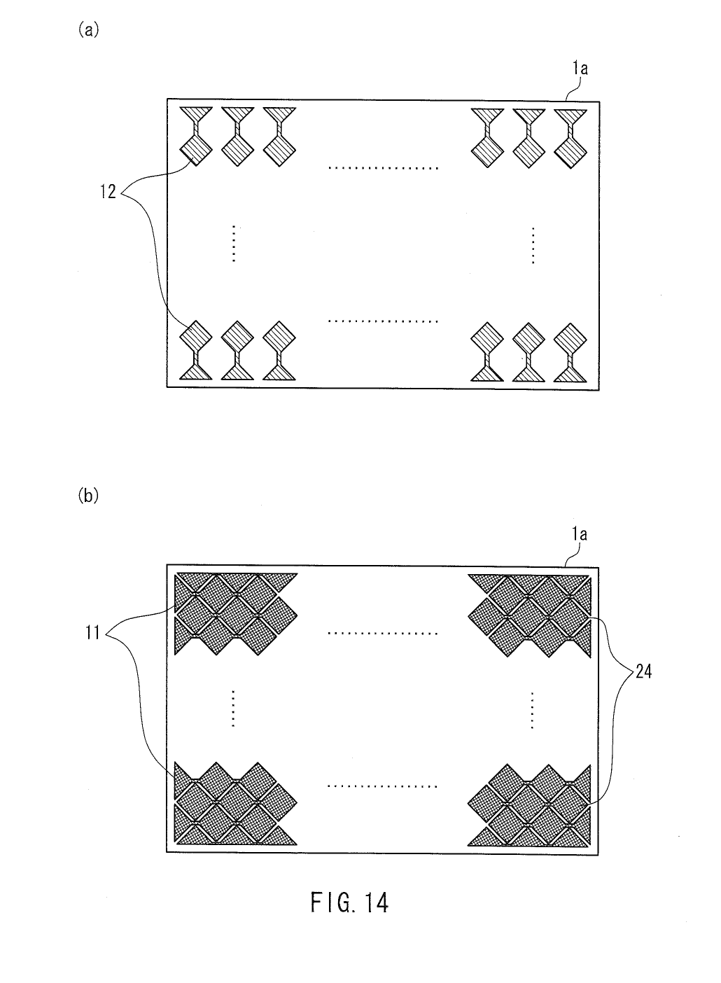

FIGS. 11 and 12 are drawings illustrating the terminal lead-out portion of the electrode forming a touch sensor.

FIG. 11 is an enlarged plan view showing the terminal lead-out portion 17 of the driving electrode 11 shown as a section A in FIG. 10. FIG. 12 is a cross-sectional view showing a cross-sectional configuration of the terminal lead-out portion 17 taken along a line a-a in FIG. 11.

As shown in FIGS. 11 and 12, in the touch sensor of the liquid crystal display device according to the present embodiment, a plurality of lead-out wiring portions 17a, which are led out from the electrode blocks at ends of the driving electrodes 11, have a through-hole connection portion 17c at their tips. Thereby they are electrically connected via an interlayer insulating film 18 to the wide common wiring portions 17b made of a low-resistance metallic material, which are formed on a back face side of the interlayer insulating film 18.

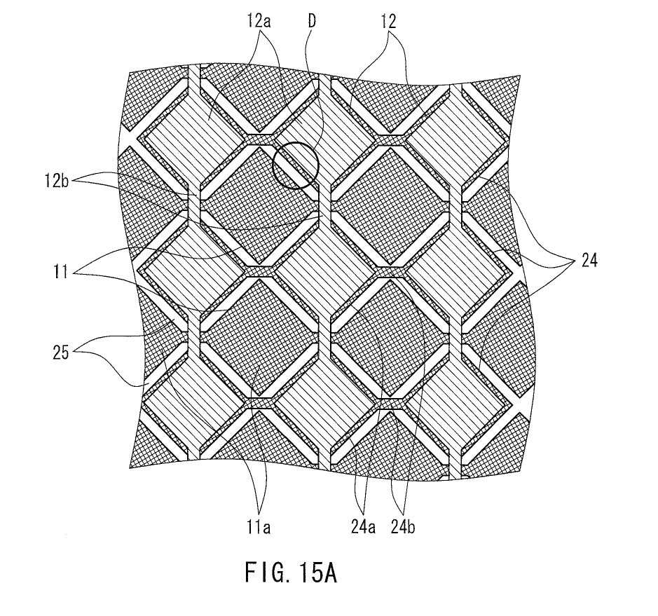

FIG. 13 is a plan view showing an exemplary configuration of one of the sub-pixels of the liquid crystal panel and the periphery thereof, in a portion indicated as a section B in FIG. 10, i.e., a portion where the detection electrode 12 of the touch sensor is formed.

As shown in FIG. 13, in the liquid crystal panel of the liquid crystal display device according to the present embodiment, on the surface of the TFT substrate 1a on the liquid crystal layer side, pixel electrodes 19 formed of a transparent conductive material such as indium tin oxide (ITO) and indium zinc oxide (IZO) TFTs 20 having source electrodes connected to the pixel electrodes 19, the scanning signal lines 10 connected to gate electrodes of the TFTs 20, and the video signal lines 9 connected to drain electrodes of the TFTs 20 are stacked via insulating films, which are formed appropriately between the respective electrode layers. Moreover, in the liquid crystal panel according to the present embodiment, the detection electrodes 12 made of a transparent conductive material such as indium tin oxide (ITO) and indium zinc oxide (IZO) and a metallic layer are formed in the periphery of the pixel electrodes 19.

Each of the TFTs 20 has a semiconductor layer, and a drain electrode and a source electrode that are ohmically connected to the semiconductor layer. The source electrode is connected to the pixel electrode 19 via a contact hole (not shown). In a lower layer of the semiconductor layer, a gate electrode connected to the scanning signal line 10 is formed.

Note that the example shown in FIG. 13 is a case in which the liquid crystal panel having a system of generating an electric field in a transverse direction with respect to the liquid crystal layer (called an IPS system) is used as the liquid crystal panel in the liquid crystal display device of the present embodiment. The pixel electrode 19 is formed in a comb tooth shape so that an electric field between the pixel electrode 19 and the common electrode extends throughout liquid crystals of an effective region constituting one sub-pixel. Further, a boundary region where the liquid crystal layer of that portion does not contribute to image display is provided so as to surround the effective region where the pixel electrode 19 is formed and the liquid crystal layer of that portion contributes to image display. In the boundary region, the scanning signal line 10 and the video signal line 9 are arranged. The TFT 20 is arranged in the vicinity of an intersection between the scanning signal line 10 and the video signal line 9.

Further, the section B FIG. 10 shown as FIG. 13 is a region where the detection electrode 12 as the electrode forming a touch sensor is formed. Because of this, in the liquid crystal panel of the liquid crystal display device according to the present embodiment, in the boundary region formed so as to surround the above-described effective region, i.e., at a position overlapping the video signal line 9 and the scanning signal line 10 in the periphery of the pixel electrode 19, the detection electrode 12 having a substantially parallel cross shape is formed so as to surround the effective region.

Although not shown in FIG. 13, in the liquid crystal panel 1 of the liquid crystal display device according to the present embodiment, a common electrode is formed so as to be opposed to the pixel electrodes 19 with an interlayer insulating film interposed therebetween. Further, in the liquid crystal panel 1 of the present embodiment, part of the common electrode is used also as the driving electrode 11 of the touch sensor.

In the portion where the common electrode used for displaying an image in the liquid crystal panel 1 is used as the driving electrode 11, shown as a section C in FIG. 10, since the electrode configuration for displaying an image as the liquid crystal panel is common, the configuration of one sub-pixel and the periphery thereof of the liquid crystal panel is substantially the same as the configuration shown in FIG. 13. However, the configuration of the portion shown in FIG. 13 as the section B in FIG. 10 and the configuration of the section C differ from each other as to whether or not the detection electrode 12 is arranged in the boundary region, which is the periphery of the effective region. As shown in FIG. 10, since the detection electrode 12 is not formed in the region shown as the section C, in the configuration of the sub-pixel and the periphery thereof of the portion shown as the section C, the detection electrode 12 that is formed so as to overlap the video signal line 9 and the scanning signal line 10 in the boundary region as shown in FIG. 13 is not present.

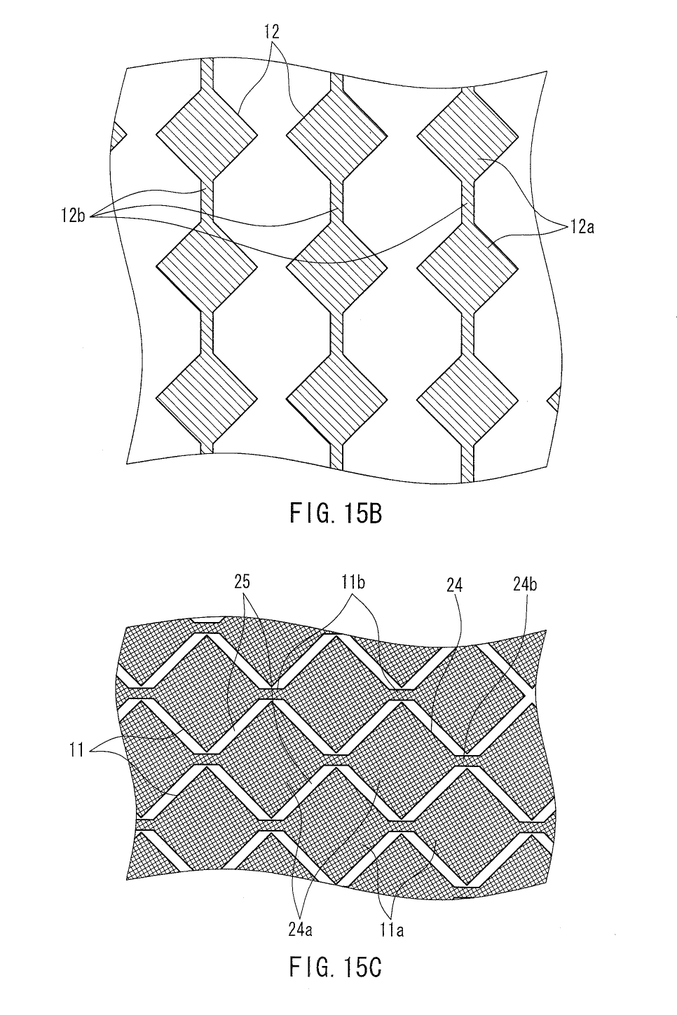

FIGS. 14(a) and 14(b) are plan views respectively illustrating arrangements of the pair of electrodes forming a touch sensor of the liquid crystal panel according to the present embodiment. FIG. 14(a) is a view illustrating an arrangement of the detection electrodes 12, showing the electrode arrangement on the pixel electrode side of the interlayer insulating layer that is formed between the pixel electrodes 19 and the common electrode as a lower layer of the pixel electrodes 19. Further, FIG. 14(b) is a view showing an arrangement configuration of the driving electrodes 11, showing an electrode arrangement of the common electrode partially serving also as the driving electrode 11, which is formed on the interlayer insulating layer formed as a lower layer of the pixel electrodes 19 on the side opposite to the pixel electrodes 19.

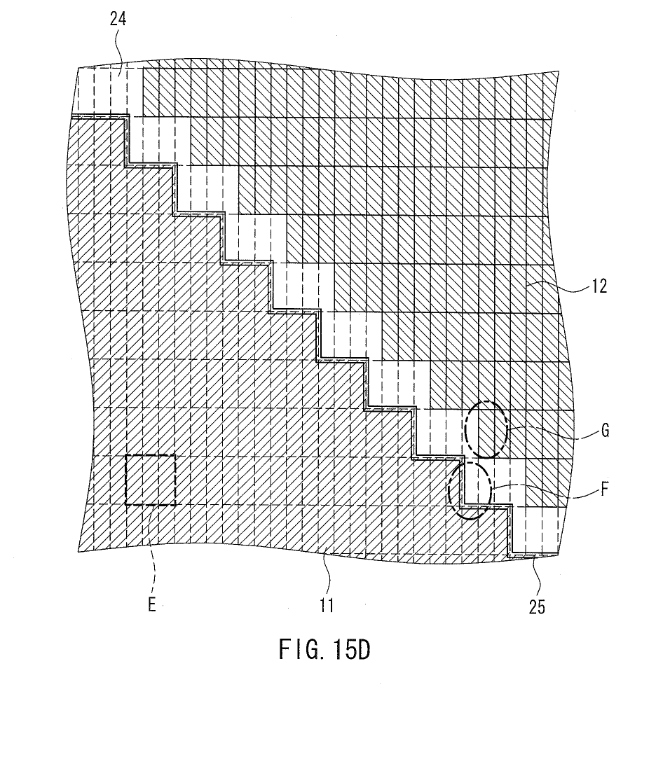

Further, FIGS. 15A, 15B, 15C and 15D are enlarged explanatory diagrams showing the common electrode of the liquid crystal panel, the driving electrodes of the touch sensor serving also as the common electrode of the liquid crystal panel, and the detection electrodes of the touch sensor. FIGS. 15A and 15D show a positional relationship among an electrode portion used only as the common electrode, the driving electrodes serving also as the common electrode, and the detection electrodes. Further, FIG. 15B shows the detection electrodes, and FIG. 15C shows, regarding the common electrode, the electrode portion used only as the common electrode and the driving electrodes serving also as the common electrode.

First, regarding the common electrode, the configuration of the electrode portion used only as the common electrode and the configuration of the driving electrode portion of the touch sensor serving also as the common electrode will be explained.

As shown in FIGS. 14(b) and 15A to 15D, the driving electrode 11 serving also as the common electrode of the liquid crystal panel is formed, as one driving electrode 11 arranged in the horizontal direction, by electrically connecting a plurality of rhombic electrode blocks 11a that are arranged separately like islands in the row direction (horizontal direction) with connection portions 11b that are formed continuously with the electrode blocks 11a in the same layer and that have an area smaller than the area of the electrode blocks 11a. The driving electrodes 11 having this configuration are arranged in a plural number in the column direction (vertical direction).

Further, electrode patterns 24 serving only as the common electrode have a shape similar to that of the driving electrodes 11 and are arranged between the driving electrodes 11 via slits 25, which electrically separate the electrode patterns 24 from the driving electrodes 11. Specifically, the electrode pattern 24 is formed, as one electrode pattern 24 arranged in the horizontal direction, by electrically connecting a plurality of rhombic electrode Mocks 24a that are arranged separately like islands in the row direction (horizontal direction) with connection portions 24b that are formed continuously with the electrode blocks 24a in the same layer and that have an area smaller than the area of the electrode blocks 24a. The electrode patterns 24 having this configuration are arranged in a plural number in the column direction (vertical direction), with the slits 25 interposed between the electrode patterns 24 and the driving electrodes 11.

As described above, in the touch sensor according to the present technology, in order to display an image in the liquid crystal panel, the slits 25 are formed to electrically divide the common electrode, which is opposed to the pixel electrodes 19 via the interlayer insulating layer in the thickness direction of the liquid crystal panel and formed in a planar shape throughout an image display surface of the liquid crystal panel as a substantially solid pattern, excluding the through hole portions formed as needed, etc. Thus, a plurality of blocks formed as rhombic islands and connection portions for connecting these blocks are formed. Then, the island-like blocks are connected in the horizontal direction by using the connection portions, whereby the driving electrodes 11 extending in the horizontal direction are formed. Further, at the same time, the remaining rhombic island-like blocks that are not used as the driving electrodes also are connected by using the connection portions in the horizontal direction, thereby serving as electrode patterns extending in the horizontal direction located between the rows of the driving electrodes.

As explained using FIG. 13, in the boundary region formed so as to surround the effective region where the pixel electrode 19 is formed in each sub-pixel of the liquid crystal panel, the detection electrode 12 as the other electrode of the touch sensor is formed at a position overlapping the video signal line 9 and the scanning signal line 10. Then, the detection electrodes, formed in the boundary regions surrounding the respective sub-pixels, are connected appropriately in the longitudinal and transverse directions, and a plurality of rhombic electrode blocks 12a, arranged in the vertical direction so as to be separated from each other like islands as a whole, are connected electrically with each other via the connection portions 12b, having an area smaller than the area of the electrode blocks 12a and formed continuously with the electrode blocks 12a in the same layer. Thus, one detection electrode 12 arranged in the longitudinal direction is formed. Then, the detection electrodes 12 having this configuration are arranged in a plural number in the horizontal direction. Thus, the driving electrodes 11 and the detection electrodes 12 form a circuit as shown in FIG. 5.

The rhombic electrode blocks 12a constituting the detection electrodes 12 are formed by electrically connecting, as a group, the detection electrodes 12 formed around the pixel electrodes 19 of a plurality of respective pixels, and arranged in the row direction in the state of being separated from each other like islands. The connection portions 12b of the detection electrodes 12 are configured by the detection electrodes 12 that are formed in other pixels present between a plurality of pixels constituting the electrode blocks 12a, and formed so as to have an area smaller than the area of the electrode blocks 12a.

Further, as shown in FIG. 15A, the electrode blocks 12a of the detection electrodes 12 are arranged so as not to be opposed to the electrode blocks 11a of the driving electrodes 11 serving also as the common electrode. In other words, the electrode blocks 12a of the detection electrodes 12 and the electrode blocks 11a of the driving electrodes 11 are arranged so that they do not overlap each other in the thickness direction of the liquid crystal panel. Further, the electrode blocks 12a of the detection electrodes 12 have an area smaller than the area of the electrode blocks 24a of the electrode pattern 24 of the common electrode, and are arranged so as to be opposed to the electrode blocks 24a of the electrode pattern 24 of the common electrode in the thickness direction of the liquid crystal panel, that is, they are stacked thereon via an interlayer insulating film.

FIG. 15 D is an enlarged view of a region shown as a section D in FIG. 15A.

The electrode blocks of the driving electrodes 11 and the electrode blocks of the detection electrodes 12 having a rhombic shape as a whole as shown in FIG. 15A are formed such that, when sub-pixels of the respective pixels are enlarged to the visible size as shown in FIG. 15D, oblique sides of the electrode blocks, actually having a rhombic shape, have a stepped shape as shown in FIG. 15D. Here, a region E shown in FIG. 15D indicates a region of one pixel composed of red (R), green (G), and blue (B) sub-pixels.

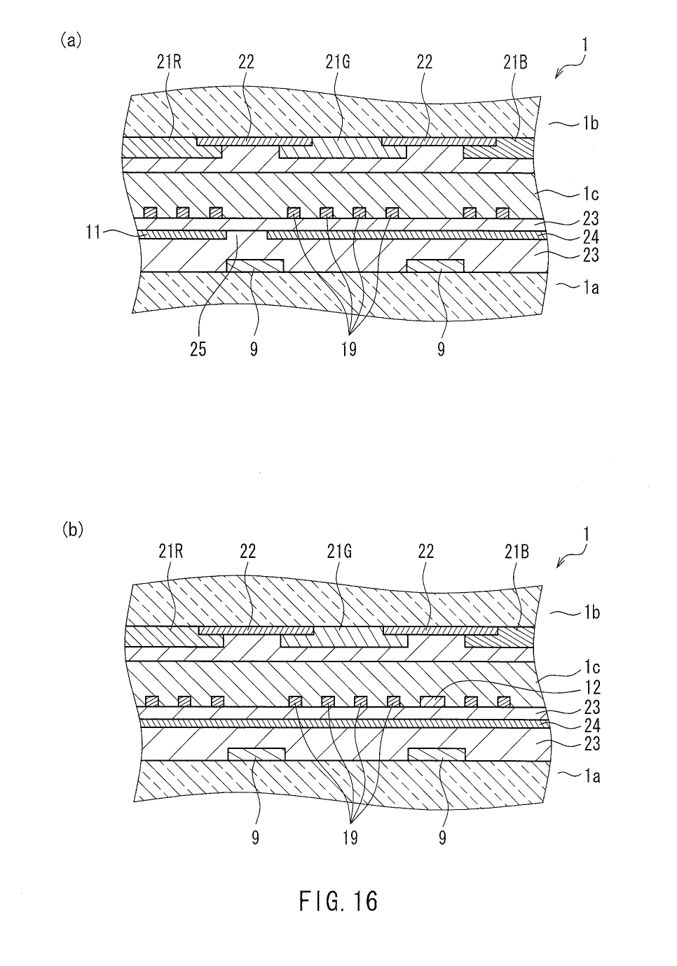

FIGS. 16(a) and 16(b) are schematic cross-sectional views showing regions F and G in FIG. 15D, respectively.

As shown in FIGS. 16(a) and 16(b), the liquid crystal panel 1 is configured by providing the TFT substrate 1a formed of a transparent substrate such as a glass substrate, and a counter substrate 1b arranged so as to be opposed to the TFT substrate 1a with a predetermined gap therebetween, and by sealing a liquid crystal material 1c between the TFT substrate 1a and the counter substrate 1b.

The TFT substrate 1a is located on the back surface side of the liquid crystal panel 1. On the surface of the transparent substrate constituting the main body of the TFT substrate 1a, there are formed pixel electrodes 19 arranged in a matrix, TFTs that are provided so as to correspond to the respective pixel electrodes 19 and that serve as switching elements for controlling ON/OFF of the application of a voltage to the pixel electrode 19, a common electrode stacked via an interlayer insulating layer so as to be opposed to the pixel electrodes 19, and the like. Incidentally, as described above, the common electrode of the liquid crystal panel 1 according to the present embodiment is divided into the portion serving also as the driving electrode 11 of the touch sensor, and the portion not serving as the driving electrode of the touch sensor and only functioning as the common electrode.

The counter substrate 1b is located on the front surface side of the liquid crystal panel 1. On the transparent substrate constituting the main body of the counter substrate 1b, color filters 21R, 21G, and 21B of three primary colors for respectively constituting sub-pixels of red (R), green (G), and blue (B), and black matrices 22 as light-shielding portions made of a light-shielding material for improving the contrast of the display image are formed. The color filters are arranged at positions overlapping the pixel electrodes 19 of the TFT substrate 1a in the thickness direction of the liquid crystal panel so as to correspond to the pixel electrodes 19. The black matrices 22 are arranged between the sub-pixels of RGB and between the pixels composed of the three sub-pixels.

Although the detailed description is omitted, as shown in FIGS. 16(a) and 16(b), similarly to general active-matrix liquid crystal panels, the interlayer insulating film 23 is formed between respective components to which a predetermined potential is applied, such as electrodes and wirings formed on the TFT substrate 1a.

As described above, on the TFT substrate 1a, a plurality of the video signal lines 9 connected to drain electrodes of the TFTs 20 and a plurality of the scanning signal lines 10 connected to gate electrodes of the TFTs 20 are arranged so as to cross each other at right angles. Each scanning signal line 10 is provided for a horizontal row of the TFTs and connected commonly to gate electrodes of a plurality of the TFTs 20 in the horizontal row. Each video signal line 9 is provided for a vertical row of the TFTs 20 and connected commonly to drain electrodes of a plurality of the TFTs 20 in the vertical row. Further, a source electrode of each TFT 20 is connected to the pixel electrode 19 corresponding to the TFT 20.

As shown in FIG. 16(a), in the liquid crystal panel of the present disclosure, in order to utilize a common electrode as the driving electrode of the touch sensor, the slit 25 is formed in the common electrode at a position opposed to the black matrix 22 of the counter substrate 1b. Thus, the driving electrode 11 of the touch sensor is formed on one side of the slit 25, and the electrode pattern 24 functioning only as the common electrode is formed on the other side of the slit 25.

Further, in the liquid crystal panel of the present disclosure, as explained using FIG. 13, the boundary region is provided so as to surround the effective region where the pixel electrode 19 is formed, and as shown in FIG. 16(b), the detection electrode 12 is formed at a position opposed to the black matrix 22 of the counter substrate 1b in the boundary region.

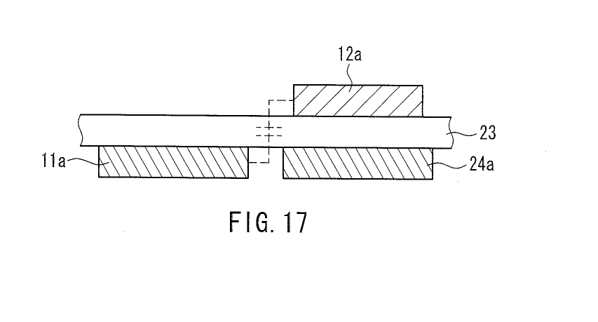

FIG. 17 is an equivalent circuit diagram between the electrode block 11a of the driving electrode 11 and the electrode block 12a of the detection electrode 12, in the configuration of the liquid crystal panel of the present disclosure explained using FIG. 15A, etc.

As shown in FIG. 17, the electrode block 11a of the driving electrode 11 and the electrode block 12a of the detection electrode 12 are arranged so as not to be opposed to each other, specifically, they are arranged so as not to overlap each other in the thickness direction of the liquid crystal panel. Therefore, as illustrated in FIG. 17, a predetermined capacitance is generated between an edge potion of the electrode block 11a and an edge portion of the electrode block 12a, which makes it possible to reduce a mutual capacitance between the driving electrode 11 and the detection electrode 12. Thus, the detection sensitivity in the operation of detecting a touch position can be enhanced (the principle has been explained using FIG. 3).

Further, as shown in FIG. 15A, the electrode block 12a of the detection electrode 12 is formed so as to have an area smaller than the area of the electrode block 11a of the driving electrode 11 and the area of the electrode block 24a of the electrode pattern 24 of the common electrode. By doing so, the electrode pattern 24 of the common electrode is present between a path from the detection electrode 12 to the driving electrode 11, which makes it possible further to reduce the mutual capacitance between the driving electrode 11 and the detection electrode 12. Consequently, in the liquid crystal panel of the present disclosure, the detection sensitivity in the operation of detecting a touch position can be enhanced further.

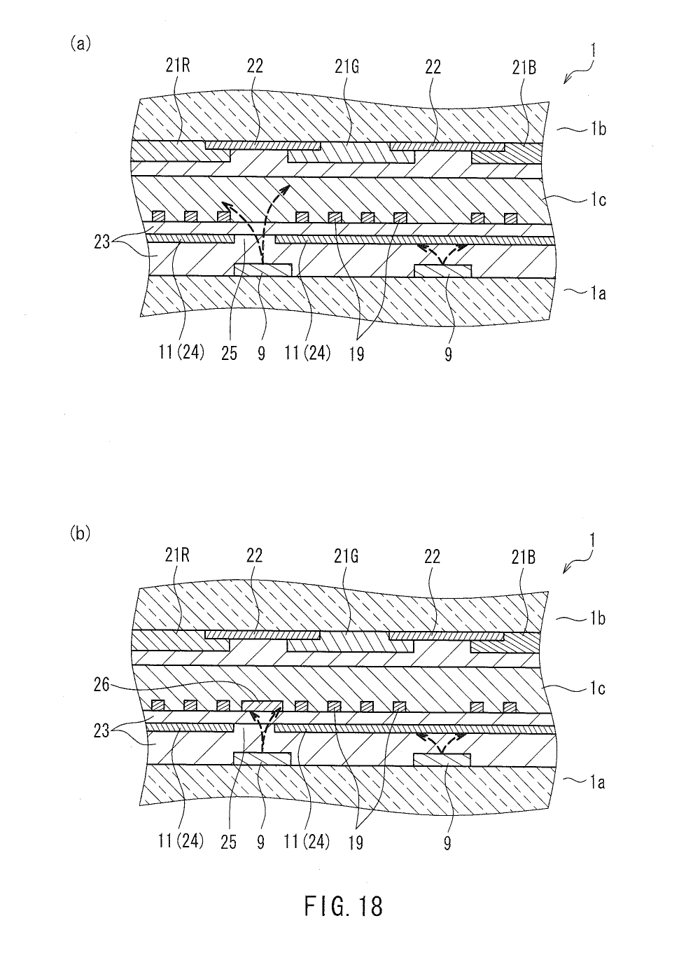

FIGS. 18(a) and 18(b) are cross-sectional views illustrating a configuration and an effect of the touch sensor in another example of the present technology

In order to use the common electrode of the liquid crystal panel 1 also as one of the electrodes of the touch sensor, in the liquid crystal panel of the present disclosure, the slits 25 are formed in the common electrode, which is generally formed as a substantially solid pattern. As Shown in FIG. 18(a), when the slits 25 are formed in the common electrode and part of the common electrode is used also as one of the electrodes of the touch sensor (the driving electrode 11 in the example shown in FIG. 18), an electric field leaked from the video signal line 9 formed in the further lower layer side of the TFT substrate 1a may reach the liquid crystal layer and disorder the alignment of liquid crystals. Especially in the case of forming rhombic island-like electrode patterns as the driving electrodes 11 and the detection electrodes 12 as the liquid crystal panel of the present embodiment, the slits 25 need to be formed in the column direction (vertical direction). However, since the video signal lines 9 also are formed in the column direction (vertical direction), the positions of the slits 25 in the column direction (vertical direction) overlap with the positions of the video signal lines 9. This increases the influence of an electric field leaked from the slits 25 formed on the upper surface of the video signal lines 9.

To cope with this, in the liquid crystal panel of the present technology, as shown in FIG. 18(b), a shielding electrode 26 is provided at a position between the pixel electrodes 19 so as to overlap the slit 25 in the thickness direction of the liquid crystal panel. That is, this position corresponds to the position of the slit 25 formed in the common electrode to allow the common electrode to be used also as the driving electrode 11 as one of the electrodes of the touch sensor. Incidentally, in the case where the shielding electrode 26 is arranged between the pixel electrodes 19, the shielding electrode 26 for suppression of an electric field is set to apply a voltage of a potential that does not affect display driving of images in the liquid crystal panel, e.g., a voltage applied to the common electrode.

Incidentally in the example shown in FIG. 18(b), the shielding electrode 26 is provided separately from the detection electrode 12 as the other electrode of the touch sensor. However, the shielding electrode 26 may be formed integrally with the detection electrode 12 of the touch sensor so as to be used also as the detection electrode 12.

As described above, by forming the shielding electrode 26 at the position overlapping the slit 25 formed in the common electrode, the shielding electrode 26 can function as a shield of an electric field leaked from the video signal line 9 formed in the lower layer of the TFT substrate 1a, thereby suppressing the disorder of the alignment of liquid crystals due to the electric field leakage.

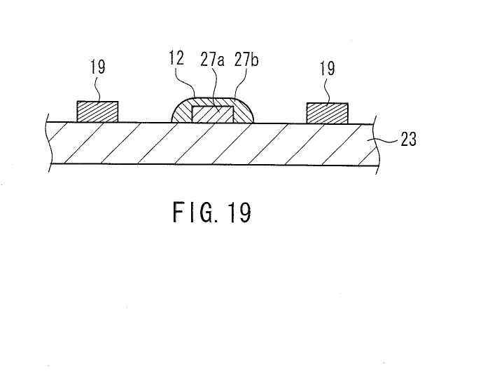

FIG. 19 is an enlarged cross-sectional view showing the detailed structure of the configuration example of the detection electrode 12 in the touch sensor according to the present technology.

Before formation of the pixel electrode 19, the detection electrode 12 having the configuration shown in FIG. 19 is formed by forming a lower layer portion 27a made of a low-resistance metallic material such as aluminum and copper on an interlayer insulating layer 23 in a predetermined pattern using a known electrode formation method such as a photosensitive exposure method, and thereafter stacking an upper layer portion 27b made of a transparent conductive material such as indium tin oxide (ITO) and indium zinc oxide (IZO) on the lower layer portion 27a by the same process as that according to the photosensitive light exposure method for forming the pixel electrodes 19.

With this configuration, low-resistance electrodes can be formed as electrodes of the touch sensor, which allows improvement in sensitivity and power-saving driving of the touch sensor.

As described above, the present technology relates to a liquid crystal display device that includes a liquid crystal panel 1 having a plurality of pixel electrodes 19 and a common electrode provided so as to be opposed to the pixel electrodes 19, and updating a display by sequentially applying a scanning signal to TFTs 20 that control application of a voltage to the pixel electrodes 19; and an input device having a plurality of driving electrodes 11, which are formed by dividing the common electrode of the liquid crystal panel 1 by providing a slit 25, and detection electrodes 12 arranged so as to cross the driving electrodes 11, and capacitive elements formed between the driving electrodes 11 and the detection electrodes 12. Further, in the liquid crystal panel 1 of the present technology, a shielding electrode 26 is arranged at a position corresponding to the slit 25 formed at a position equivalent to the periphery of the pixel electrodes 19. By doing, so, the present technology can play a role in shielding an electric field leaked from the drain electrodes of the TFTs 20 formed in the lower layer portion of the TFT substrate 1a, thereby suppressing the disorder of the alignment of liquid crystals. Further, it is effective to set the shielding electrode 26 at the same voltage as that applied to the common electrode.

### INDUSTRIAL APPLICABILITY

As described above, the present technology is an invention useful as a liquid crystal display device including a capacitance coupling type input device.

1. A liquid crystal display device, comprising:
a liquid crystal panel having a plurality of pixel electrodes and a common electrode provided so as to be opposed to the pixel electrodes, and updating a display by sequentially applying a scanning signal to switching elements that control application of a voltage to the pixel electrodes; and
an input device having a plurality of driving electrodes formed in the liquid crystal panel and a plurality of detection electrodes arranged so as to cross the driving electrodes, and capacitive elements formed between the driving electrodes and the detection electrodes,
wherein, in the input device, the driving electrodes are formed by dividing the common electrode of the liquid crystal panel by providing a slit at a position corresponding to the periphery of the pixel electrodes, and
a shielding electrode is arranged at a position corresponding to the slit.

2. The liquid crystal display device according to claim 1, wherein the shielding electrode is set at the same potential as that of a voltage applied to the common electrode.
